(19) United States
(12) Patent Application Publication
(10) Pub. No.: US 2013/0016412 A1
(43) Pub. Date: Jan. 17, 2013

(54) POLARITON BASED ALL-OPTICAL SPIN DEVICE

(71) Applicants: Taofiq PARAÏSO, Geneva (CH); Yoan Léger, Evian-les-Bains (FR); Roland Cerna, Chavannes-Renens (CH); François Morier-Genoud, Vevey (CH); Benoît Deveaud-Plédran, Lausanne (CH)

(72) Inventors: Taofiq PARAÏSO, Geneva (CH); Yoan Léger, Evian-les-Bains (FR); Roland Cerna, Chavannes-Renens (CH); François Morier-Genoud, Vevey (CH); Benoît Deveaud-Plédran, Lausanne (CH)

(73) Assignee: ECOLE POLYTECHNIQUE FEDERALE DE LAUSANNE (EPFL), Lausanne (CH)

(21) Appl. No.: 13/456,988

(22) Filed: Apr. 26, 2012

Related U.S. Application Data
(60) Provisional application No. 61/480,413, filed on Apr. 29, 2011.

(51) Int. Cl. G02F 3/00

(52) U.S. Cl. 359/108

(57) ABSTRACT

An all-optical spin device is based on spin multistability of trapped microactivity polaritons.

### FIELD OF INVENTION

The present invention relates to optical processing and/or, in particular but not exclusively, to optical memories and logic gates.

### STATE OF THE ART

In the recent years, different groups have developed a variety of optical memories—often referred to as all-optical flip-flops—and of logic gates. A selection of those projects is briefly presented in this chapter.

### i) Phase Dependent Switches

There are several realizations of optical polarization switches and AOFF working with holding beam and writing pulses. The use of holding beam is important to maintain the polarization state for durations longer than the lifetime of the spin carriers in the device. However the existing solutions using semiconductor heterostructures often rely on the relative phase between the switching pulses (see for instance EP 0809128 and EP 1128204 A1), which is difficult to control, and prevent to write information by sending pulses with arbitrary time delays.

### ii) Wavelength Dependent

Other switching solutions provide devices which are based on the competition between two different wavelengths: see for instance U.S. Pat. No. 5,151,589 A, EP 1255157 A1, U.S. Pat. No. 6,456,417 B1 and references 1 and 2 as follows:
Ref 1=Liu et al., Proceedings Symposium IEEE/LEOS Benelux Chapter, 2003, Enschede;
Ref 2=Liu et al., Proceedings Symposium IEEE/LEOS Benelux Chapter, 2003, Enschede.

The use of different wavelengths for the different polarization states prevents the coupling of polarization keying with WDM and for cascading several devices.

iii) XGM/XPM

Cross gain modulation (XGM) devices, like semiconductor optical amplifiers (SOA), also allow for AOFF operations but were only demonstrated with low contrast (3, 5 dB) and slow switching speed (˜1 ns) (U.S. Pat. No. 6,456,417 B1, US 2009 067300 A1).

XGM uses input beams at different wavelengths than the main lasing mode for creating injection locking and causing lasing on a side-mode; in this way the lasing of the main mode can be suppressed if the gain losses induced by the side modes are high enough. One problem with this approach is that different wavelengths with specific requirements are involved. As a consequence there is no cascadability, meaning that output of such a gate cannot be used as input for an identical gate, preventing for building arrays.

### iv) Spatial Mode Competition

More generally XGM is also used to obtain switches with spatial effect, like the change of the lasing direction of a disk laser-see references 3-5 as follows:
Ref 3=Liu Liu et al., Nat. Photon. 4, (2010);
Ref 4=M. T: Hill et al., Nature (2004);
Ref 5=IEEE PHOTONICS TECHNOLOGY LETTERS, VOL. 17, NO. 5, MAY 2005.

These techniques also prevent from cascading devices or to use them in optical fibers.

### v) Polarization Multistability

Recent peer reviewed publications proposed to use polarization multistability using semiconductor microcavities in the strong coupling regime to realize AOFFs-see references 6 and 7 as follows:
Ref 6=IEEE PHOTONICS TECHNOLOGY LETTERS, VOL. 17, NO. 5, MAY 2005;
Ref 7=IEEE PHOTONICS TECHNOLOGY LETTERS, VOL. 17, NO. 5, MAY 2005.

The advantage of polarization multistability with respect to the prior art is that it discretizes the polarization states into only 2 or 3 available states. This ensures a stabilization of the polarization states and drastically increases the possibilities for designing logical components for optical processing.

However the proposal of a RAM device (see Ref 7) relies on the control of the relative phase between the switching pulses, which has previously been shown to be problematic.

However, for most all-optical logic circuits schemes, fluctuations and losses are considered as an important drawback for communication between optical stages.

There is therefore a need to improve the state-of-the-art devices.

### SUMMARY OF THE INVENTION

In a first aspect the invention provides an all-optical spin device based on spin multistability of trapped microcavity polaritons.

In a first preferred embodiment the all-optical spin device according to the invention comprises a pulse laser for fast switching between an upper and a lower intensity branch.

In a second preferred embodiment the all-optical spin device according to the invention comprises a continuous wave laser as a power supply for polariton spin populations.

In a third preferred embodiment of the all-optical spin device according to the invention, the continuous wave laser is linearly polarized.

In a second aspect the all-optical spin device according to the invention is used for storing information (optical memory).

In a third aspect the all-optical device according to the invention is used for logic operations (logic gating).

### BRIEF DESCRIPTION OF THE FIGURES

The invention is described with reference to figures, which illustrate various aspects thereof.

FIG. 1 illustrates a circular polarization degree of the emission coming from the device (y-axis) as a function of the circular polarization degree of the cw-pump (x-axis). Excitation wavelength and power is kept constant all the time;

FIG. 2 contains a number of graphs used for a characterization of the memory device. For this purpose the device was excited with a cw laser at 0.4 meV above the eigenenergy. The dotted yellow vertical lines mark the cw laser parameters used for the memory operation. For a and b the cw laser was linearly polarized and the excitation power was scanned. a displays the bistability of the spin-up (red) and spin-down (green) polariton populations on a logarithmic scale. We observe independent lower thresholds. b shows the polarization degree obtained from a. A clear switching behavior can be observed. c shows the output circular polarization as a function of the circular polarization of the pump. Pump power was constant as indicated by dotted lines in a and b. (By putting the excitation power at 1.75 mW (see a) we obtain the multistability displayed in FIG. 1). d Illustration of two states spin flip operation with polarized laser pulses;

FIG. 3 shows experimental results for the RAM operation. A linearly polarized single mode cw laser excites the system in the spin multistability region. (1.75 mW in FIG. 2a) Polarized laser pulses are used to switch between the different branches. a The time resolved and signals clearly demonstrate a switching behavior when the respectively pulses arrive. b The corresponding time resolved circular polarization degree displays a complete spin flip from spin up to spin down within 5 ps and then back again. c By using linearly polarized pulses it is also possible to switch to linear polarization, where both spin populations are on the upper bistability branch;

FIG. 4 illustrates aspects of monochromatic spin gates;

FIG. 5 illustrates aspects of cascadability-output of a logic gate that can serve as direct input for another gate;

FIG. 6 contains a simplified diagram of an all-optical RAM based on a preferred embodiment of the device according to the invention;

FIG. 7 illustrates a mode of operation of a two valued (+ and −) all-optical memory based on a preferred embodiment of the device according to the invention. By using as well linear pulses it is also possible to switch between three values.

### DESCRIPTION OF THE INVENTION

An elegant way of solving the problems mentioned in the previous sections is to encode logic levels independently from the optical intensity. Optical spinor systems are therefore excellent candidates to develop such devices since the spin polarization can be used for storing information as well as for logic operations.

The invention therefore relates to an all-optical spin device based on spin multistability of trapped microcavity polaritons.

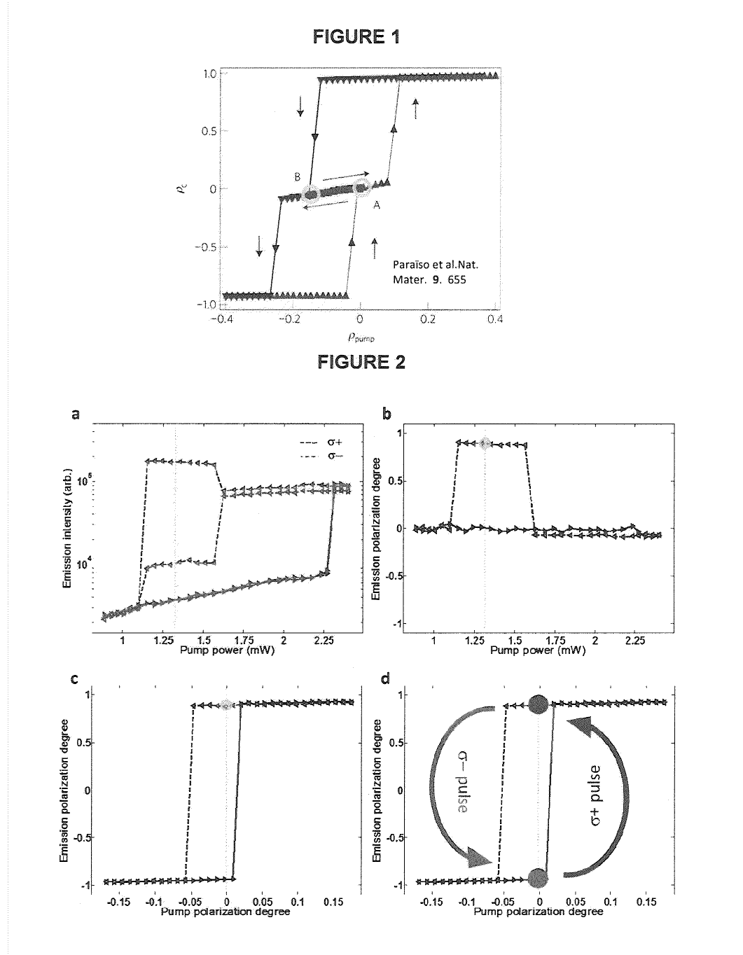

The device according to the present invention may admit two or more stable spin states for a given single optical excitation condition. The device is preferably driven by a single wavelength continuous wave (cw) excitation laser. This optical cw may be replaced for instance by electrical pumping through resonant tunneling. The switching between the different states can be achieved at constant excitation power by changing the excitation polarization (using a quarter-wave plate). The light emitted by the device has preferably the same wavelength as the input light. The polarization of the light emitted by the device is advantageously in one-to-one correspondence with the internal spin state of the device (see FIG. 1).

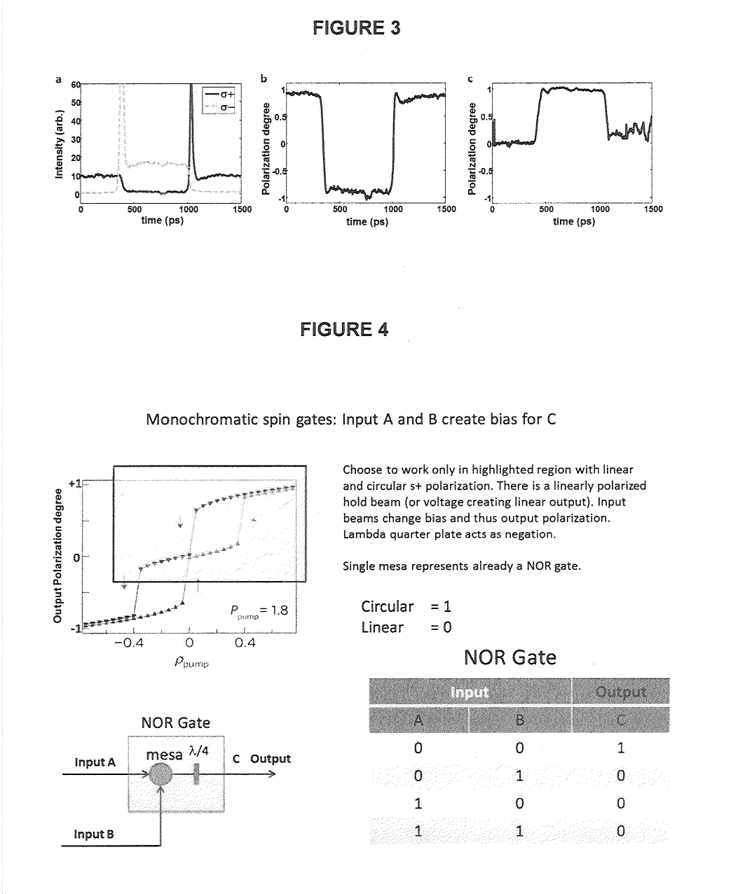

Ultrafast, selective and reversible switching is achieved by keeping the continuous wave beam in the multistability region (with constant power and polarization) as a holding beam and by sending circularly (left, right) or linearly polarized sub-picosecond pulses to write the internal spin state of the device. After the pulse is gone, the information on the spin polarization is conserved as long as the holding beam is exciting the device. This may serves as an all-optical RAM where the information is encoded in the polarization state. The operation device does neither depend on the relative phase between the pulses nor on the phase between the pulses and the holding beam (see FIGS. 2 and 3).

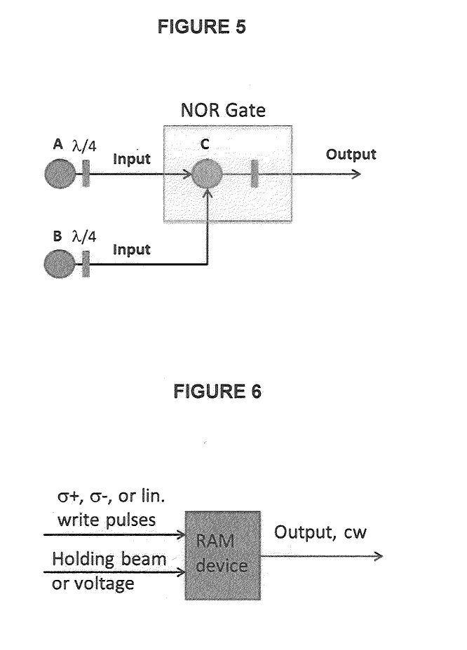

Fundamental logic operations (e.g. NOR) are realized with a single device using polarized optical inputs. The preferable monochromatism of the device allows for cascadability by using the output of one device as the input of another device. More complex logic operations may be obtained using arrays of several of these devices (see FIGS. 4 and 5).

The present invention takes advantage from a situation called “cross dissipation modulation (XDM)”, i.e. the dissipation of a spin population in the device increases with the density of the other spin population. This leads to population competition.

XDM can be modulated in the vicinity of a Feshbach resonance for instance, like the biexciton resonance. It is important to stress the fact that XDM is a physical process which is substantially different from XGM.

Polarization switching is realized with ultrafast pulses independently from their relative phase. The output of the device has preferably the same wavelength as the input.

The invention preferably works with narrow linewidth polaritons, by using for instance lateral confinement in patterned structures and by using polariton energies close to the biexciton resonance. The very narrow polariton linewidth makes the behavior much more sensitive to energy variations close to the resonance. Bistability cycles are realized with excitation powers which are preferably more than two orders of magnitude lower than in other microcavity structures (see reference ref 8=Baas et al., PRA 69 023809, (2004)).

Because of the narrow linewidths the effect of XDM is much more significant on the upper bistability branches (for a high polariton density), causing a separation of lower bistability thresholds of spin-up and spin-down polaritons. The independence of the lower thresholds is advantageous to decrease the power consumption (<500 μW). Multistability can be realized in the region of independent lower thresholds.

XDM is responsible for the buildup of a reservoir and provides higher contrast (e.g. 20 dB) and more robust output polarization states. The device output is circular s+(1), s−(−1) or linear (0). It is possible to design the device to obtain a 0-state which is elliptical and to modify the symmetry of the multistability cycle.

The device according to the present invention is a versatile, multi-valued, optical polarization device which may be advantageously used in optical communication, optical processing and fiber optics technology. Some of those applications are briefly discussed below.

### i) Optical Communication

Telecom industry is facing two important challenges: on the one hand, there is an exponential increase of the number of users and on the other hand, the economic and climatic situations are calling for a significant reduction of the energetic costs.

In order to address the increase of traffic in the communication networks, wavelength-division-multiplexing (WDM) technology imposed itself as the most suitable technology in optical communication. Until very recently, the signal modulation was only encoded into the amplitude of the optical signals of different wavelengths (ON-OFF-Keyed, OOK). This format however suffers from poor spectral efficiency, limiting the increase of information fluxes. Since these fluxes will soon reach the Tbit/s regime, new modulation methods are nowadays developed. These new formats include phase modulation (PSK, Phase-Shift-Keyed) or polarization modulation (POLSK) and appear to be promising alternative solutions. This is discussed in references 9-12 as follows:
Ref 9=Benedetto et al. IEEE trans. Comm. 40 708 (1992);
Ref 10=Ciaramella et al. J. Lightwave tech. 24 4039 (2006);
Ref 11=Fludger et al. J. Lightwave Tech. 26, 64 (2008);
Ref 12=Evangelides et al. J. Lightwave Tech. 10, 28 (1992).

### ii) Polarization Keying

There are two main issues about polarization keying. The first one is the polarization sensitivity of opto-electronic devices such as semiconductor spin amplifiers (SOA). With the development of specific semiconductor nanostructures (OD columnar stacks) this problem has recently been solved [Akiyama et al. Proceedings of the IEEE 95, 1757 (2007)]. The second issue is the conservation of polarization through optical fibers, which is weak. The problem of polarization conservation in fibers is still being investigated.

### ii) Fiber Optics Technology

It is a general feature in fiber optics technologies that the polarization degree of freedom is not exploited. As said previously, it is in general very difficult to maintain a given polarization state along a fiber. This is problematic not only for fiber optics communication but also for other applications, like for instance, fiber sensing, where fluctuations of the polarization is critical and can introduce artifacts in temperature/strain measurements. Polarization maintaining fibers are very expensive and their use have a lot of restrictions (ways to enter the fiber, short-length fibers only).

A possible solution consists in the amplification of the signal at certain positions only and at the same time to correct the polarization. The device according to the present invention provides a solution for polarization correction in optical networks.

iii) Optical Processing

The main obstacle to the development of optical processing is the lack of a simple, transistor-like, optical-component that can be used to control light flow as well as to realize logic operations. A proper storage element like an optical RAM is also difficult to design (see ref 13=D. A. B. Miller, Nature Photonics 4, 3-5 (2010)) when using state-of-the-art devices.

### iv) Ternary Logic

Ternary logic has for long been proposed as a powerful solution to compute complex algorithm.

However the difficulty to design a standalone multistable component compromises the development of ternary circuits. Instead, ternary functions are implemented using binary functions, which makes them even more complicated.

The present invention provides a solution to achieve polarization multistability devices that can be addressed reversibly with ultrafast pulses while being insensitive to the phase of the pulses.

The invention was in particular tested and confirmed in a semiconductor microcavity in the strong-coupling regime with patterned structures used to trap exciton-photon mixed states (polaritons).

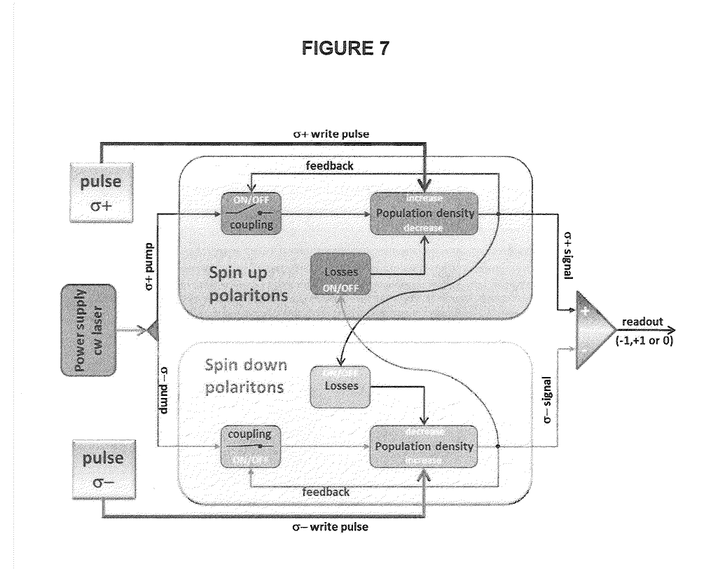

### Description of an all Optical Polarization Switching Device (See FIGS. 6 and 7)

In this example designed for two memory values, the device comprises a cw and a pulsed laser with femtosecond pulses for optically creating and controlling the polariton populations in the sample. The cw laser is linearly polarized for being able to pump the spin up and spin down polariton populations and has an energy slightly above the polariton eigenenergy. The laser pulses are split in two and the two pulses are then counter circularly polarized (+ and −). A delay line controls the time difference between the two pulses. The experiments are performed in transmission with the sample at liquid helium temperature. On the detection side the signals coming from the spin up and spin down polaritons are separated and detected with a spectrometer and a streak camera for time resolved measurements. The linearly polarized cw laser can serve as a power supply for both polariton populations and the laser pulses allow us to control for which polariton population the supply is ON or OFF (write operation). A − pulse for example brings the spin down population up and hence in resonance with the power supply. Due to the feedback created by the self-induced blueshift the supply will remain on after the pulse. The spin down pupulation surplus created by the − pulse induces at the same time non-linear losses which bring down the spin up population and hence cut it off from the power supply. For obtaining a high contrast we use the polarization degree of the emitted signal as value of the memory. The readout values can be −1 (if memory written with −), +1 (if memory written with +) or 0 (memory not yet written).

For three memory values the same operation can be achieved in exactly the same conditions using a pulse and a linear pulse. Hence, the system can reversibly and selectively be switched between right-circular, left-circular, and linearly polarized. 3-state polarization modulation can be achieved at a rate higher than 0.2 THz.

In summary:
1. The present invention provides a high quality polar/spin multistable device operating at single wavelength.
2. Because of the narrow linewidth and the XDM, the lower bistability thresholds of spin-up and spin-down polaritons are independent.
3. The invention is preferably operating at constant input power, between the two lower thresholds. For a given range of excitation polarization, the internal spin state, hence the transmission polarization, may admit three stable and independent values.
4. The spin state of the system (or transmission polarization) can be used as a logical value for the design of switches, memories, and other processing components.
5. The invention may generate the spin Schmitt trigger regime, which is the direct analog of the electronic Schmitt trigger for spins.
6. The invention provides very high contrasts (>95%), low power consumption.
7. The invention solves a major problem of selective ultrafast switching since it allows to switch independently from the phase of the switching pulses.
8. The invention can be used as fundamental logic gate OR/NOR. It is also suitable for cascading and arrays can be built to design other logic operations.
9. The embodiment of the invention can be used to correct light polarization at the output of an optical fiber.

1. All-optical spin device based on spin multistability of trapped microcavity polaritons.

2. All-optical spin device according to claim 1 comprising a pulse laser for fast switching between an upper and a lower intensity branch.

3. All-optical spin device according to claim 1 comprising a continuous wave laser as a power supply for polariton spin populations.

4. All-optical spin device according to claim 3 wherein said continuous wave laser is linearly polarized.

5. All-optical spin device according to claim 1 for storing information (optical memory).

6. All-optical device according to claim 1 for logic operations (logic gating).
